(19) United States
(12) Patent Application Publication
(10) Pub. No.: US 2010/0272364 A1
(43) Pub. Date: Oct. 28, 2010

(54) IMAGE EDITING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/496,657

(22) Filed: Jul. 2, 2009

(30) Foreign Application Priority Data
Apr. 23, 2009 (CN) 200910301777.0

(51) Int. Cl. G06K 9/46; G06K 9/36

(52) U.S. Cl. 382/190; 382/284

(57) ABSTRACT

An image editing system examines plurality of first images from a video input unit to obtain coordinates of key portion of a first image, and stores the coordinates of the key portions into a storage system. The image editing system further stores a plurality of second images, and reads the coordinates of the key portions and replaces portion of the first image corresponding to coordinates with the second image.

### BACKGROUND

1. Technical Field

The present disclosure relates to image processing systems and methods, and more particularly to an image editing system and an image editing method.

2. Description of Related Art

Network cameras are getting more and more popular nowadays. However, there are times when users may not want others to know their figures or location while using the camera.

### BRIEF DESCRIPTION OF THE DRAWINGS

FIG. 1 is a schematic diagram of an exemplary embodiment of an image editing system.

FIG. 2 is a schematic diagram of a first image edited into a second image with the image editing system of FIG. 1.

FIG. 3 is a flowchart of an exemplary embodiment of an image editing method used for the image editing system of FIG. 1.

### DETAILED DESCRIPTION

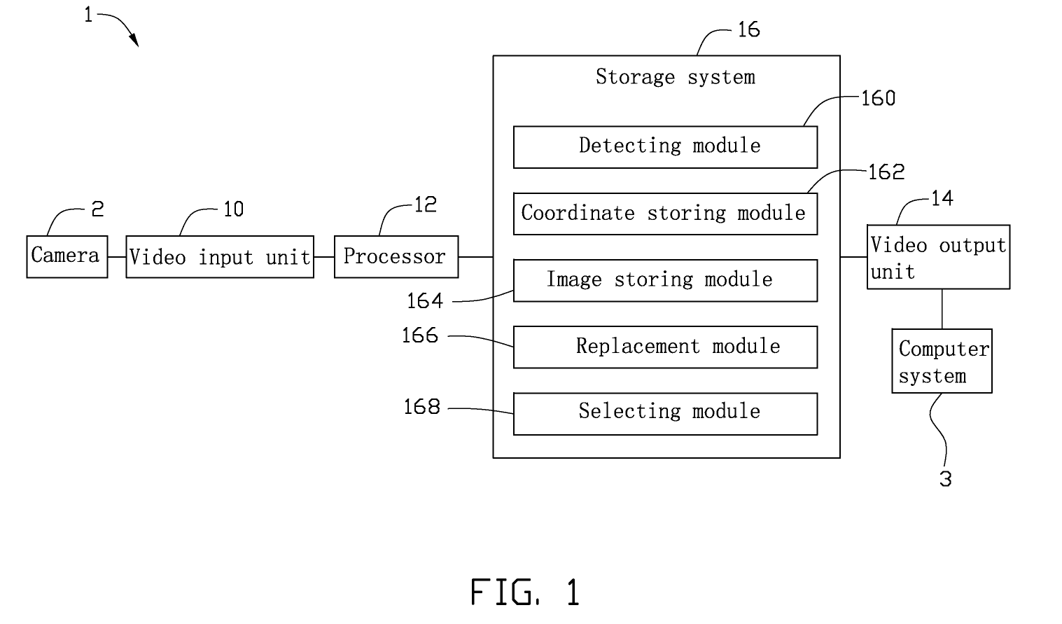

Referring to FIG. 1, an exemplary embodiment of an image editing system 1 includes a video input unit 10, a processor 12, a video output unit 14, and a storage system 16. The image editing system 1 is operable to edit a plurality of first images from the video input unit 10 to get a plurality of second images.

The storage system 16 includes a detecting module 160, a coordinate storing module 162, an image storing module 164, a replacement module 166, and a selecting module 168. The detecting module 160, the coordinate storing module 162, the image storing module 164, the replacement module 166, and the selecting module 168 may include one or more computerized instructions and are executed by the processor 12.

The video input unit 10 is coupled to an image capture device, such as a camera 2, to transmit the plurality of first images captured by the camera 2 to the storage system 16. The detecting module 160 is operable to examine each of the plurality first images and obtain coordinates of key portions of each first image. It can be understood that known recognition technology is employed by the detecting module 160 to obtain key portion coordinates. The key portions, in one example, may include faces or license plates in each first image.

The processor 12 stores the coordinates of the key portions in the coordinate storing module 162. The image storing module 164 stores a plurality of second images in advance. The plurality of second images may include various images from webpages, such as tigers, or cartoons. The replacement module 166 is operable to read coordinates in the coordinate storing module 162 and replace portions of each first image corresponding to the coordinates with a second image in the image storing module 164. A computer system 3 is operable to receive edited images from the replacement module 166 via the video output unit 14.

The selecting module 168 is operable to select which types of key portions are detected by the detecting module 160. For example, users can select a face or a license plate as the key portion in each first image.

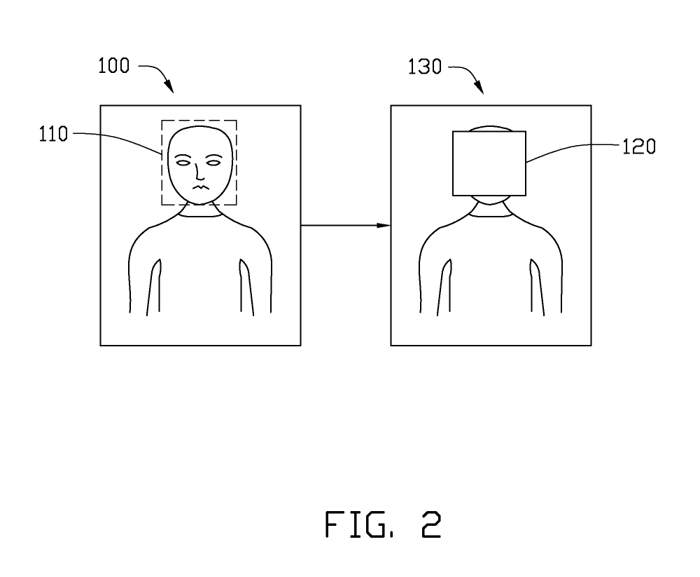

Referring to FIG. 2, the video input unit 10 transmits a first image 100 captured by the camera 2 to the storage system 16. The detecting module 160 examines the first image 100 with known recognition technology, to get a face 110 in the first image 100, and obtain coordinates of the face 110 in the first image 100, such as (0,0), (2,0), (2,2), and (0,2). It can be understood the face 110 is ranged between the four coordinates.

The replacement module 166 reads coordinates in the coordinate storing module 162 and replace portions of the first image 100 corresponding to the coordinates with a second image 120, such as a tiger, in the image storing module 164. As a result, the computer system 3 receives an edited image 130, which has the tiger replaced the face 110 in the first image 100, from the replacement module 166 via the video output unit 14.

In other embodiments, the image editing system 1 can be coupled to a television or a mobile phone with a video function. In addition, the computer system 3 can be another mobile phone with a video function.

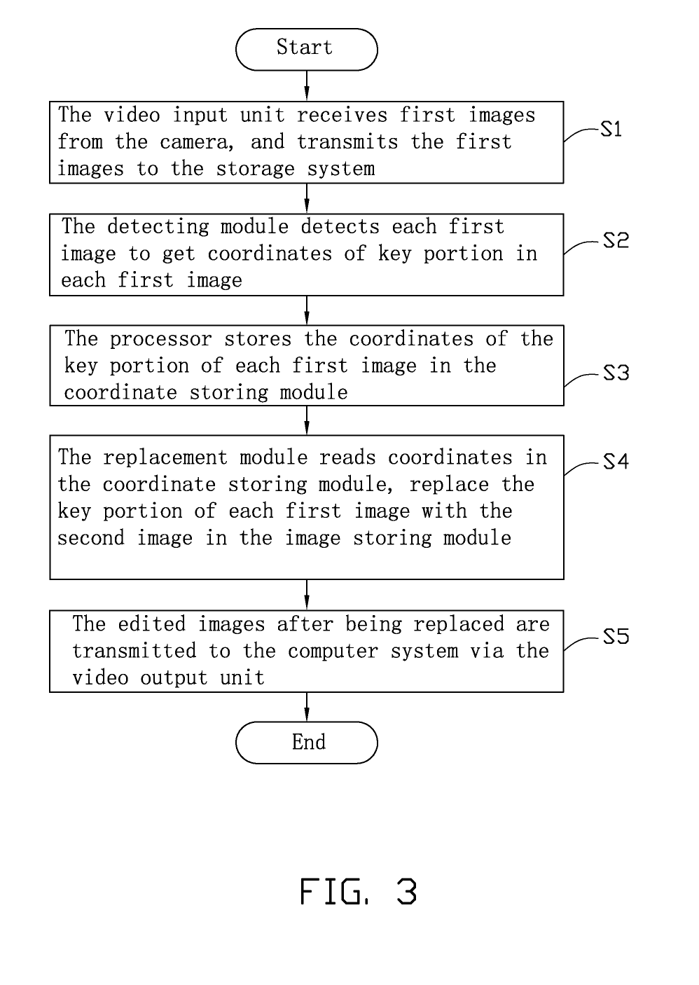

Referring to FIG. 3, an exemplary embodiment of an image editing method includes the following steps.

In step S1, the video input unit 10 receives the plurality of first images from the camera 2, and transmits the plurality of first images to the storage system 16.

In step S2, the detecting module 160 examines each of the plurality of first images to get coordinates of key portion of each first image. As mentioned above, the key portions of each first image may include a face or a license plate in each first image. In the embodiment, the detecting module 160 examines the first image 100 to get coordinates of the face 110 in the first image 100, which are (0,0), (2,0), (2,2), and (0,2). It can be understood the face 110 is ranged between the four coordinates.

In step S3, the processor 12 stores the coordinates of the key portion of each first image in the coordinate storing module 162. In the embodiment, the processor 12 stores the coordinates (0,0), (2,0), (2,2), and (0,2) in the coordinate storing module 162.

In step S4, the replacement module 166 reads coordinates of the key portion of each first image in the coordinate storing module 162, and replace the key portion of each first image with the second image in the image storing module 164 corresponding to the coordinates to get a plurality of edited images.

In the embodiment, the replacement module 166 reads coordinates (0,0), (2,0), (2,2), and (0,2) in the coordinate storing module 162 and replace portions of the first image 100 corresponding to the coordinates (0,0), (2,0), (2,2), and (0,2) with the second image 120 in the image storing module 164 to get the edited image 130 which has the second image 120 replaced the face 110 in the first image 100.

In step S5, the edited images are transmitted to the computer system 3 via the video output unit 14.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An image editing system, comprising:
a processor;
a storage system connected to the processor and storing one or more computerized instructions being executed by the processor, wherein the storage system comprises:
a detecting module to examine a plurality of first images captured by an image capture device to obtain coordinates of key portions of each of the plurality of first images;
a coordinate storing module to store the coordinates of the key portion of each first image in the storage system;
an image storing module to store a plurality of second images; and
a replacement module to read the coordinates of key portions of each first image in the coordinate storing module and replace portions of each first image corresponding to the coordinates of key portions of each first image in the coordinate storing module with the second image in the image storing module.

2. The image editing system of claim 1, wherein the storage system further comprises a selecting module operable to select which type of key portion of each first image is detected by the detecting module.

3. The image editing system of claim 1, wherein the key portion of each first image is a face.

4. An image editing method, comprising:
examining a plurality of first images captured by an image capture device to obtain key portions of each of the plurality of first image;
storing coordinates of the key portions of each first image;
reading the coordinates of key portions of each first image; and
replacing portion of each first image corresponding to the coordinates of key portions of each first image with a second image.

5. The image editing method of claim 4, wherein before the step “examining a plurality of first images captured by an image capture device to obtain key portions of each of the plurality of first image” further comprises:
selecting which type of key portion of each first image is detected.
